(19) United States
(12) Patent Application Publication
(10) Pub. No.: US 2017/0120560 A1
(43) Pub. Date: May 4, 2017

(54) APPARATUS AND SHEET

(71) Applicant: Kabushiki Kaisha Toshiba, Tokyo (JP)

(72) Inventor: Kazuyuki KINJOU, Yokohama Kanagawa (JP)

(21) Appl. No.: 15/053,595

(22) Filed: Feb. 25, 2016

Related U.S. Application Data
(60) Provisional application No. 62/247,425, filed on Oct. 28, 2015.

(51) Int. Cl. B32B 7/12; G06F 1/16; B32B 3/02

(52) U.S. Cl. CPC B32B 7/12; B32B 3/02; G06F 1/1633; B32B 2405/00

(57) ABSTRACT

According to an embodiment, an apparatus includes a sheet member, a housing, and a first pressure-sensitive adhesive. The sheet member includes a cover and an outer edge surrounding the cover. At least a part of the sheet allows light to pass therethrough. The housing includes a surface. The first pressure-sensitive adhesive is provided on the outer edge, is configured to allow the sheet member to removably adhere to the surface, and is configured to block a portion between the surface and the cover.

### CROSS-REFERENCE TO RELATED APPLICATIONS

This application is based upon and claims the benefit of priority from U.S. Provisional Application No. 62/247,425, filed on Oct. 28, 2015; the entire contents of which are incorporated herein by reference.

### FIELD

Embodiments to be described herein relate generally to an apparatus and a sheet.

### BACKGROUND

There is a case in which a sheet is attached to a surface of an apparatus. The sheet covers the surface of the apparatus.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view illustrating a portable computer according to a first embodiment;

FIG. 2 is an exemplary perspective view illustrating a back cover according to the first embodiment;

FIG. 3 is an exemplary plan view illustrating the back cover according to the first embodiment;

FIG. 4 is an exemplary side view illustrating a part of the back cover according to the first embodiment;

FIG. 5 is an exemplary plan view illustrating a back cover according to a second embodiment;

FIG. 6 is an exemplary plan view illustrating a back cover according to a third embodiment;

FIG. 7 is an exemplary plan view illustrating a part of a back cover according to a fourth embodiment; and

FIG. 8 is an exemplary plan view illustrating a part of a back cover according to a fifth embodiment.

### DETAILED DESCRIPTION

In general, according to an embodiment, an apparatus includes a sheet member, a housing, and a first pressure-sensitive adhesive. The sheet member includes a cover and an outer edge surrounding the cover. At least a part of the sheet allows light to pass therethrough. The housing includes a surface. The first pressure-sensitive adhesive is provided on the outer edge, is configured to allow the sheet member to removably adhere to the surface, and is configured to block a portion between the surface and the cover.

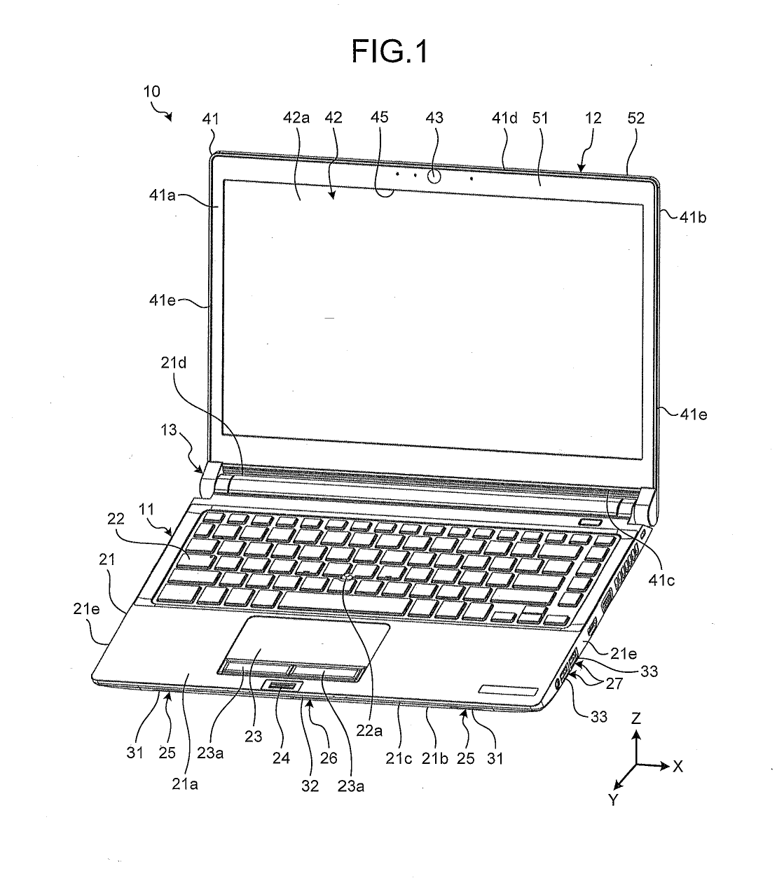

Hereinafter, a first embodiment will be described with reference to FIGS. 1 to 4. Incidentally, the present specification basically defines a user side as a forward direction, a side away from the user as a rearward direction, a left side seen from the user as a leftward direction, a right side seen from the user as a rightward direction, an upper side seen from the user as an upward direction, and a lower side seen from the user as a downward direction. Further, constituent elements or descriptions of the elements according to the embodiment will be sometimes described with a plurality of expressions. It is not hindered to use other expressions not described herein regarding the constituent element and the description thereof. In addition, it is not hindered to use other expressions regarding constituent elements and descriptions thereof which are not described with a plurality of expressions.

FIG. 1 is an exemplary perspective view illustrating a portable computer 10 according to the first embodiment. The portable computer 10 is an example of the apparatus. The apparatus may be a tablet, a television receiving apparatus, a display, a smartphone, a mobile phone, consumer electronics or other apparatuses.

As illustrated in FIG. 1, the portable computer 10 includes a base portion 11, a display unit 12, and a hinge portion 13. Each of the base portion 11, the display unit 12, and the hinge portion 13 can be referred to also as a part.

As illustrated in the respective drawings, the present specification defines an X-axis, a Y-axis, and a Z-axis. The X-axis, the Y-axis, and the Z-axis are orthogonal to each other. The X-axis is defined along a width (horizontal length) of the display unit 12. The Y-axis is defined along a thickness (depth) of the display unit 12. The Z-axis is defined along a height (vertical length) of the display unit 12.

The base portion 11 includes a first housing 21, a keyboard 22, a touch pad 23, a fingerprint detection module 24, two speakers 25, a card reading device 26, and a plurality of connectors 27.

The first housing 21 accommodates the fingerprint detection module 24, the speakers 25, the card reading device 26, and the connectors 27. The first housing 21 further accommodates, for example, a motherboard, to which a CPU and a memory are mounted, a storage such as a solid state drive (SSD), and a battery.

The first housing 21 is formed substantially in a rectangular box shape. The first housing 21 may be formed in another shape. The first housing 21 includes an upper face 21a, a bottom face 21b, a front end portion 21c, a rear end portion 21d, and two side end portions 21e. The bottom face 21b is positioned at the opposite side of the upper face 21a. The rear end portion 21d is positioned at the opposite side of the front end portion 21c.

In the state illustrated in FIG. 1, the upper face 21a is directed in the upward direction. The bottom face 21b is directed in the downward direction. The front end portion 21c is an end portion of the first housing 21 in the forward direction. The rear end portion 21d is an end portion of the first housing 21 in the rearward direction. Each of the two side end portions 21e is an end portion of the first housing 21 in a direction along the X-axis, that is, the leftward direction or the rightward direction.

The keyboard 22, the touch pad 23, and the fingerprint detection module 24 are provided on the upper face 21a. The speakers 25 and the card reading device 26 are provided in the front end portion 21c. The connectors 27 is provided in one of the side end portions 21e.

The keyboard 22 is a device configured to input information in the portable computer 10. The keyboard 22 is provided with a pointing stick 22a. The pointing stick 22a is a pointing device.

The touch pad 23 is a pointing device. The touch pad 23 is disposed closer to the front end portion 21c of the first housing 21 than the keyboard 22 is. The touch pad 23 is provided with two buttons 23a for a click operation.

The fingerprint detection module 24 is a device configured to detect a fingerprint of the user of the portable computer 10. The fingerprint detection module 24 is disposed closer to the front end portion 21c of the first housing 21 than the touch pad 23 is. Incidentally, the fingerprint detection module 24 may be disposed at another location such as between the two buttons 23a of the touch pad 23.

Each of the speakers 25 is a device configured to generate a sound. Two speaker openings 31 are provided at the front end portion 21c of the first housing 21. Each of the speakers 25 emits the sound to the outside of the first housing 21 through the corresponding speaker opening 31.

The card reading device 26 is a device configured to perform read and write of data of a memory card, for example. An insertion port 32 is provided on the front end portion 21c of the first housing 21. For example, the memory card is inserted into the card reading device 26 or extracted from the card reading device 26 through the insertion port 32.

The plurality of connectors 27 include various types of connectors such as USB connectors. A plurality of connector openings 33 are provided on one of the side end portions 21e of the first housing 21. Each of the connectors 27 is inserted into or extracted from a corresponding plug through the corresponding connector opening 33.

The display unit 12 is attached to the rear end portion 21d of the first housing 21 of the base portion 11 by the hinge portion 13. The display unit 12 is rotatable between a closing position at which the display unit 12 covers the upper face 21a of the first housing 21 and an opening position at which the display unit 12 is raised from the rear end portion 21d of the first housing 21.

The display unit 12 includes a second housing 41, a display module 42, and a camera 43. The second housing 41 is an example of the housing and an object. The second housing 41 accommodates the display module 42 and the camera 43. The second housing 41 further accommodates, for example, an antenna.

The second housing 41 is formed substantially in a rectangular box shape. The second housing 41 may be formed in another shape. The second housing 41 includes a front face 41a, a back face 41b, a proximal end portion 41c, a distal end portion 41d, and two side end portions 41e. The back face 41b is an example of the surface.

The front face 41a is directed in a positive direction along the Y-axis, that is, the forward direction. The front face 41a faces the upper face 21a of the first housing 21 in a case in which the display unit 12 is at the closing position. The back face 41b is positioned at the opposite side of the front face 41a. The back face 41b is directed in a negative direction along the Y-axis, that is, the rearward direction.

The proximal end portion 41c is an end portion of the second housing 41 in a negative direction along the Z-axis, that is, the downward direction. The proximal end portion 41c extends in the direction along the X-axis. The proximal end portion 41c is connected to the base portion 11 by the hinge portion 13 in a rotatable manner.

The distal end portion 41d is positioned at the opposite side of the proximal end portion 41c. The distal end portion 41d is an end portion of the second housing 41 in a positive direction along the Z-axis, that is, the upward direction. The distal end portion 41d extends in the direction along the X-axis.

The respective two side end portions 41e are end portions of the second housing 41 in the direction along the X-axis, that is, the leftward direction or the rightward direction. The respective two side end portions 41e extend in the direction along the Z-axis.

A display opening 45 is provided in the front face 41a of the second housing 41. The display module 42 includes a screen 42a to display an image. The screen 42a is an example of a display face. The screen 42a is exposed to the outside of the second housing 41 through the display opening 45. The screen 42a is disposed at the opposite side of the back face 41b.

The camera 43 is disposed closer to the distal end portion 41d of the second housing 41 than the display module 42 is. The camera 43 captures an image in a direction in which the front face 41a is directed by a lens provided in the front face 41a, for example.

The second housing 41 includes a front bezel 51 and a back cover 52. The front bezel 51 is made of synthetic resin, for example. The back cover 52 is made of a magnesium alloy and synthetic resin using insert molding, for example. Each of the front bezel 51 and the back cover 52 may be made of another material.

The front bezel 51 forms the front face 41a of the second housing 41. The display opening 45 is provided in the front bezel 51. In other words, the front bezel 51 is formed like a frame to surround the display opening 45.

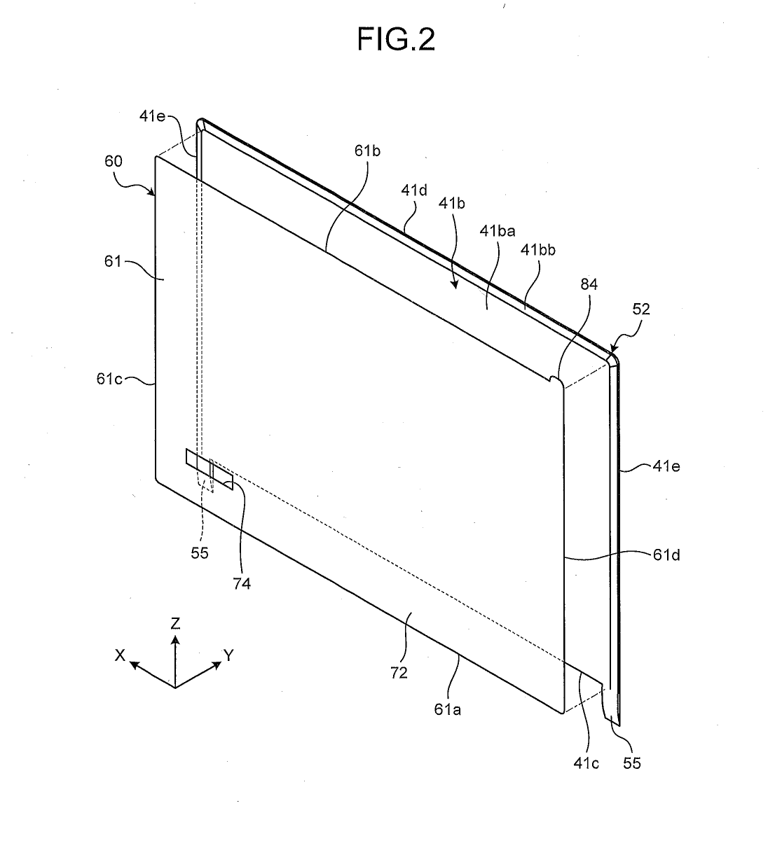

FIG. 2 is an exemplary perspective view illustrating the back cover 52 of the first embodiment. The front bezel 51 is fitted in the back cover 52. The front bezel 51 and the back cover 52, which are fixed to each other, form the second housing 41.

The back cover 52 includes two hinge covers 55. Each of the hinge covers 55 protrudes from the proximal end portion 41c of the second housing 41 in the negative direction along the Z-axis. The two hinge covers 55 are spaced apart from each other in the direction along the X-axis. The hinge cover 55 covers a part of the hinge portion 13.

The back face 41b of the second housing 41 of the present embodiment is clear coated. For example. To be specific, a surface of a base material of the back cover 52 which is formed using the insert molding, for example, is coated with color paint. At least one layer is formed on the color paint using transparent paint. The back face 41b is formed by the layer of the transparent paint. A surface roughness of the back face 41b is smoother than a surface roughness of the surface of the base material of the back cover 52.

The paint used for forming the back face 41b of the second housing 41 is made of synthetic resin of, for example, polyurethane. The paint used for forming the back face 41b may be made of another synthetic resin such as an ultraviolet curable resin. In addition, the back face 41b may be also made of another material such as metal, glass, or ceramics. The back face 41b made of metal may be subjected to mirror finishing. The surface roughness of the back face 41b made of the paint may be the same as or rougher than the surface roughness of the surface of the base material of the back cover 52.

The back face 41b of the second housing 41 includes a planar face 41ba and a curved face 41bb. The curved face 41bb is an example of a spacing portion. The planar face 41ba is a flat face having an approximately rectangular shape. The curved face 41bb surrounds the planar face 41ba from the positive direction along the Z-axis, and the direction along the X-axis. In other words, the curved face 41bb is disposed between the planar face 41ba and the distal end portion 41d, between the planar face 41ba and one of the side end portions 41e, and between the planar face 41ba and the other one of the side end portions 41e. The curved face 41bb is formed so as to be spaced apart from the planar face 41ba as proceeding in the positive direction along the Y-axis.

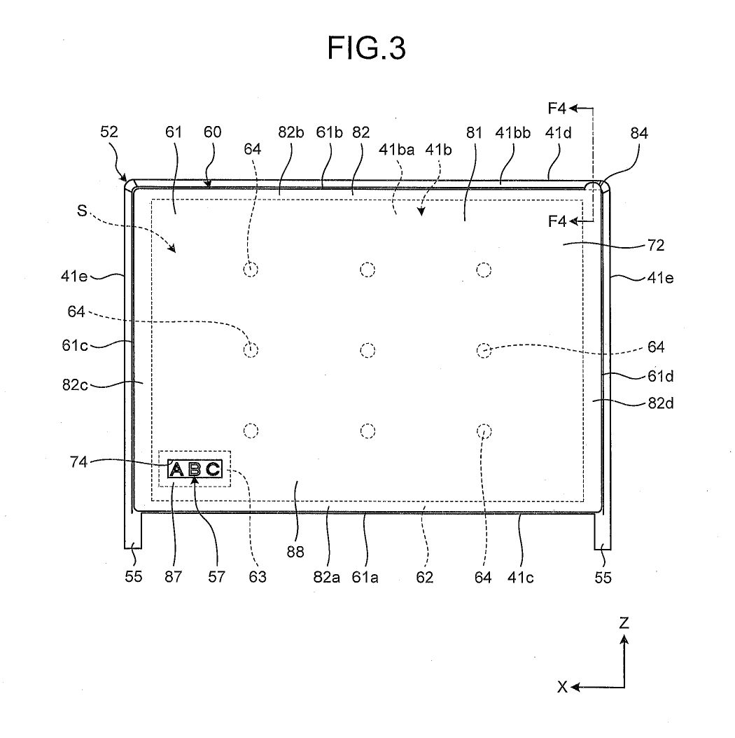

FIG. 3 is an exemplary plan view illustrating the back cover 52 of the first embodiment. As illustrated in FIG. 3, a logotype 57 is provided on the back face 41b of the second housing 41. The logotype 57 is an example of a disposed portion. The disposed portion is not limited thereto, but may be another part or component such as a camera, for example.

The logotype 57 is disposed on the planar face 41ba of the back face 41b. The logotype 57 includes at least one among letters, symbols and figures, for example, to display various types of information.

The logotype 57 is formed using paint made of synthetic resin of polyurethane, for example, and is provided on the back face 41b by screen printing. The logotype 57 may be, for example, made of metal and provided on the back face 41b by adhesion. A material of the logotype 57 is different from the material of the back face 41b in terms of at least one of components and colors, for example.

As illustrated in FIG. 2, a sheet 60 is attached onto the back face 41b of the second housing 41. The sheet 60 covers at least a part of the back face 41b, and protects the back face 41b while the portable computer 10 is transported, for example. When the user uses the portable computer 10, the sheet 60 may be peeled off from the portable computer 10.

A mode of the sheet 60 described above is an example. For example, the sheet 60 may decorate the portable computer 10, may improve a sense of feeling of the portable computer 10, or may remain in the state of covering the back face 41b when the user uses the portable computer 10.

As illustrated in FIG. 3, the sheet 60 includes a sheet member 61, a first pressure-sensitive adhesive 62, a second pressure-sensitive adhesive 63, and a plurality of third pressure-sensitive adhesives 64. The sheet member 61 can be referred to also as a sheet, a film, a protective member, a member, and a component. Each of the first to third pressure-sensitive adhesives 62 to 64 can be referred to also as, for example, an adhesive, an attachment portion, a fixing portion, or a part.

The sheet member 61 is made of synthetic resin of polyethylene terephthalate (PET) or polycarbonate, for example. The sheet member 61 is formed in an approximately rectangular shape. The sheet member 61 may be made of another material, and be formed in another shape.

The sheet member 61 includes a first end edge 61a, a second end edge 61b, a third end edge 61c, and a fourth end edge 61d. The first to fourth end edges 61a to 61d are end faces of the sheet member 61.

The first end edge 61a is directed in the negative direction along the Z-axis, that is, the downward direction. The second end edge 61b is positioned at the opposite side of the first end edge 61a. The second end edge 61b is directed in the positive direction along the Z-axis, that is, the upward direction.

The third end edge 61c is directed in a positive direction along the X-axis, that is, the leftward direction. The fourth end edge 61d is positioned at the opposite side of the third end edge 61c. The fourth end edge 61d is directed in a negative direction along the X-axis, that is, the rightward direction.

The first end edge 61a and the second end edge 61b extend in the direction along the X-axis so as to be parallel to each other. The third end edge 61c and the fourth end edge 61d extend in the direction along the Z-axis so as to be parallel to each other. The third end edge 61c connects one end of the first end edge 61a and one end of the second end edge 61b. The fourth end edge 61d connects the other end of the first end edge 61a and the other end of the second end edge 61b.

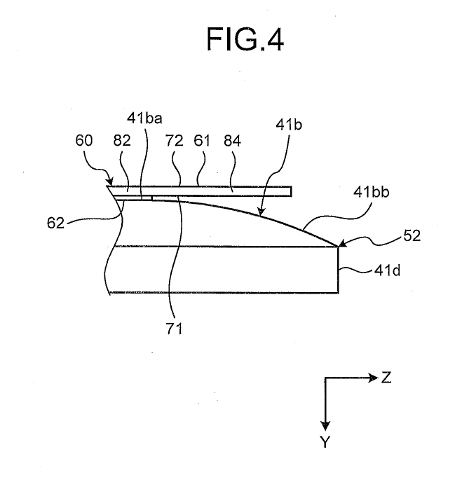

FIG. 4 is an exemplary side view illustrating a part of the back cover 52 of the first embodiment along line F4-F4 of FIG. 3. As illustrated in FIG. 4, the sheet member 61 includes a pasting face 71 and an outer face 72.

The pasting face 71 is a substantially flat face which is directed toward the back face 41b of the second housing 41. The pasting face 71 is directed in the positive direction along the Y-axis, that is, the forward direction. The outer face 72 is positioned at the opposite side of the pasting face 71. The outer face 72 is directed in the negative direction along the Y-axis, that is, the rearward direction.

In the present embodiment, the sheet member 61 is a gray translucent sheet, and light can pass through the sheet member 61. For example, the sheet member 61 may have another color or may be transparent. A part of the sheet member 61 may shield light.

As illustrated in FIG. 3, an opening 74 is provided in the sheet member 61. The opening 74 is a hole which is formed in, for example, a substantially rectangular shape, and penetrates the sheet member 61. The opening 74 is opened in the pasting face 71, and is opened in the outer face 72. The opening 74 may be a cutout which is provided in the sheet member 61, for example.

The opening 74 has a size which is capable of surrounding the logotype 57 when the opening 74 overlaps with the logotype 57. In other words, the opening 74 in a case in which the sheet member 61 is seen in a plan view as illustrated in FIG. 3 is larger than a region in which the logotype 57 is provided in a case in which the back face 41b is seen in a plan view. In a case in which the logotype 57 includes three letters as illustrated in FIG. 3, for example, the opening 74 can surround the three letters.

The sheet member 61 includes a cover 81, an outer edge 82, and a tab 84. The tab 84 is an example of a peelable portion in the present embodiment. Each of the cover 81, the outer edge 82, and the tab 84 can be referred to also as a part.

The cover 81 is a part of the sheet member 61, and is formed approximately in a rectangular shape. The cover 81 may be formed in another shape. The cover 81 forms a part of the pasting face 71 and a part of the outer face 72.

The outer edge 82 is a frame-like part of the sheet member 61, and surrounds the cover 81 having approximately a rectangular shape from the direction along the X-axis and the direction along the Z-axis. In other words, the outer edge 82 is disposed between the cover 81 and the first end edge 61a, between the cover 81 and the second end edge 61b, between the cover 81 and the third end edge 61c, and between the cover 81 and the fourth end edge 61d. It can be also expressed that the outer edge 82 forms the first to fourth end edges 61a to 61d. The outer edge 82 forms a part of the pasting face 71 and a part of the outer face 72.

The outer edge 82 includes a first long side 82a, a second long side 82b, a first short side 82c, and a second short side 82d. The second long side 82b is an example of a first extension portion in the present embodiment. The second short side 82d is an example of a second extension portion in the present embodiment.

Each of the first long side 82a and the second long side 82b is extended in the direction along the X-axis. The direction along the X-axis is an example of a first direction in the present embodiment. The first long side 82a is disposed between the cover 81 and the first end edge 61a. The second long side 82b is disposed between the cover 81 and the second end edge 61b.

In the present embodiment, the first long side 82a forms a part of the pasting face 71 and a part of the outer face 72 which are adjacent to the first end edge 61a. The second long side 82b includes a part of the pasting face 71 and a part of the outer face 72 which are adjacent to the second end edge 61b.

Each of the first short side 82c and the second short side 82d is extended in the direction along the Z-axis. The direction along the Z-axis is an example of a third direction and a crossing direction in the present embodiment. The first short side 82c is positioned between the cover 81 and the third end edge 61c. The second short side 82d is positioned between the cover 81 and the fourth end edge 61d.

In the present embodiment, the first short side 82c includes part of the pasting face 71 and a part of the outer face 72 which are adjacent to the third end edge 61c. The second short side 82d includes a part of the pasting face 71 and a part of the outer face 72 which are adjacent to the fourth end edge 61d.

The first short side 82c is connected to an end portion of the first long side 82a and an end portion of the second long side 82b. The second short side 82d is connected to the other end portion of the first long side 82a and the other end portion of the second long side 82b.

Each width (dimension) of the first and second long sides 82a and 82b in the direction along the Z-axis is shorter than each width (dimension) of the first and second short sides 82c and 82d in the direction along the X-axis. The direction along the Z-axis is an example of a direction which is orthogonal to the first direction in the present embodiment. The direction along the X-axis is an example of a direction which is orthogonal to the third direction in the present embodiment. Each width (dimension) of the first and second long sides 82a and 82b in the direction along the Z-axis may be longer than each width (dimension) of the first and second short sides 82c and 82d in the direction along the X-axis.

The opening 74 is provided in the cover 81. The cover 81 includes an inner edge 87 and an interposed portion 88. The inner edge 87 is a frame-like part of the cover 81, and surrounds the opening 74 having a substantially rectangular shape from the direction along the X-axis and the direction along the Z-axis. It can be also expressed that the inner edge 87 forms the opening 74. The interposed portion 88 is interposed between the inner edge 87 and the outer edge 82. Thus, the inner edge 87 is surrounded by the outer edge 82 at a position spaced apart from the outer edge 82.

The tab 84 protrudes from the second long side 82b of the outer edge 82 in the positive direction along the Z-axis. The positive direction along the Z-axis is an example of a second direction in the present embodiment. The tab 84 is set to protrude from a part to which the second long side 82b of the outer edge 82 and the second short side 82d are connected. The outer edge 82 is disposed between the cover 81 and the tab 84. A width of the tab 84 is shorter than a width of the second long side 82b, in the direction along the X-axis.

The first to third pressure-sensitive adhesives 62 to 64 are adhesives made of synthetic resin of, for example, an aqueous dispersion acrylic adhesive. Each of the first to third pressure-sensitive adhesives 62 to 64 may be a member such as another adhesive or a double-sided tape which enables an object to adhere to another object.

The first pressure-sensitive adhesive 62 is provided on the pasting face 71 of the outer edge 82. The pasting face 71 is coated with the first pressure-sensitive adhesive 62 in each of the first long side 82a, the second long side 82b, the first short side 82c, and the second short side 82d of the outer edge 82.

The outer edge 82 is a part of the sheet member 61, the first pressure-sensitive adhesive 62 provided in the part. The outer edge 82 in which the first pressure-sensitive adhesive 62 is not yet provided may be distinguishable from the cover 81. For example, a line may be provided between the cover 81 and the outer edge 82. The first pressure-sensitive adhesive 62 provided on the outer edge 82 surrounds the cover 81.

The second pressure-sensitive adhesive 63 is provided on the pasting face 71 in the inner edge 87. The inner edge 87 is a part of the sheet member 61, the second pressure-sensitive adhesive 63 provided in the part. The inner edge 87 in which the second pressure-sensitive adhesive 63 is not yet provided may be distinguishable from the interposed portion 88. For example, a line may be provided between the inner edge 87 and the interposed portion 88. The second pressure-sensitive adhesive 63 provided on the inner edge 87 surrounds the opening 74. The second pressure-sensitive adhesive 63 is surrounded by the first pressure-sensitive adhesive 62 at a position spaced apart from the first pressure-sensitive adhesive 62.

Each of the plurality of third pressure-sensitive adhesives 64 is provided on the pasting face 71 in the interposed portion 88. The plurality of third pressure-sensitive adhesives 64 are spaced apart from each other, spaced apart from the first pressure-sensitive adhesive 62, and further, spaced apart from the second pressure-sensitive adhesive 63.

The entire area of the plurality of third pressure-sensitive adhesives 64 being provided on the interposed portion 88 is smaller than the area of the first pressure-sensitive adhesive 62 being provided on the outer edge 82. In other words, a sum of the area of respective parts of the pasting face 71 coated with the plurality of third pressure-sensitive adhesives 64 is smaller than the area of the part coated with the first pressure-sensitive adhesive 62 of the pasting face 71.

In the present embodiment, each of the plurality of third pressure-sensitive adhesives 64 is formed in a substantially circular shape (punctiform). The third pressure-sensitive adhesive 64 is not limited thereto, and may be formed in various types of shapes such as a quadrangular shape, a rectangular, and a triangular shape. In addition, only one of the third pressure-sensitive adhesives 64 may be provided.

The first to third pressure-sensitive adhesives 62 to 64 are provided on the pasting face 71 using screen printing. That is, the pasting face 71 is coated with the adhesive to form the first to third pressure-sensitive adhesives 62 to 64 through a mesh. The first to third pressure-sensitive adhesives 62 to 64 may be provided using another method.

The first to third pressure-sensitive adhesives 62 to 64 allow the sheet member 61 to removably adhere to the back face 41b of the second housing 41. For example, each surface of the first to third pressure-sensitive adhesives 62 to 64 has a plurality of fine spherical parts. Thus, the sheet member 61 adhering to the back face 41b by the first to third pressure-sensitive adhesives 62 to 64 can be peeled off from the back face 41b. The sheet member 61 peeled off from the back face 41b can be attached to the back face 41b again by the first to third pressure-sensitive adhesives 62 to 64. The first to third pressure-sensitive adhesives 62 to 64 are not limited thereto. When the sheet member 61 is attached to the back face 41b, the logotype 57 is surrounded by the opening 74. Thus, the logotype 57 is exposed.

The first pressure-sensitive adhesive 62 provided on the outer edge 82 and the second pressure-sensitive adhesive 63 provided on the inner edge 87 block a portion between the back face 41b of the second housing 41 and the interposed portion 88 of the cover 81. To be specific, a space S is formed between the back face 41b and the interposed portion 88 in a state in which the sheet member 61 is attached to the back face 41b by the first to third pressure-sensitive adhesives 62 to 64. The space S has at least one of a gap between the back face 41b and the interposed portion 88 and a part at which the back face 41b and the interposed portion 88 are in contact with each other. In other words, the space S may include a boundary part at which the back face 41b and the interposed portion 88 are in contact with each other.

As illustrated in FIG. 3, the space S is formed between the first pressure-sensitive adhesive 62 and the second pressure-sensitive adhesive 63 in a case in which the back face 41b is seen in a plan view. In other words, the space S overlaps with the interposed portion 88 of the cover 81.

The first pressure-sensitive adhesive 62 and the second pressure-sensitive adhesive 63 are configured to block the space S. The first and second pressure-sensitive adhesives 62 and 63 in the present embodiment enable the space S to be watertight or airtight. In other words, the first and second pressure-sensitive adhesives 62 and 63, which allow the sheet member 61 to adhere to the back face 41b of the second housing 41, are configured to allow the space S to be watertight or airtight. Each of the first and second pressure-sensitive adhesives 62 and 63 is not limited thereto.

As above, the first and second pressure-sensitive adhesives 62 and 63 allow the sheet member 61 to adhere to the back face 41b of the second housing 41 so as to form the blocked space S. In addition, the plurality of third pressure-sensitive adhesives 64 allow the interposed portion 88 of the sheet member 61 to adhere to the back face 41b at a plurality of positions.

The first to third pressure-sensitive adhesives 62 to 64 in the present embodiment allow the sheet member 61 to adhere to the planar face 41ba of the back face 41b. Each of the first to third pressure-sensitive adhesives 62 to 64 may allow the sheet member 61 to adhere to the curved face 41bb of the back face 41b.

The first to third pressure-sensitive adhesives 62 to 64 are provided outside the tab 84. The tab 84 is movable with respect to the back face 41b of the second housing 41. As illustrated in FIG. 3, the tab 84 overlaps with the curved face 41bb of the back face 41b in a case in which the back face 41b is seen in a plan view. In other words, the pasting face 71 in the tab 84 is directed to the curved face 41bb of the back face 41b.

As illustrated in FIG. 4, the tab 84 is spaced apart from at least a part of the curved face 41bb of the back face 41b in the negative direction along the Y-axis. In other words, a gap is interposed between the tab 84 and the curved face 41bb of the back face 41b. The curved face 41bb is formed to be separated from the tab 84 as being separated from the planar face 41ba. The tab 84 may be set to protrude in a direction to be separated from the back face 41b as being separated from the outer edge 82.

In general, when a sheet member of which the entire region is coated with a pressure-sensitive adhesive is attached to a surface of an object, there is a case in which air bubbles remaining between the pressure-sensitive adhesive and the surface impairs a fine view. For example, a difference in color is caused between a part of the sheet member which is attached to the surface by the pressure-sensitive adhesive and a part which is not attached to the surface due to the air bubbles present therein. However, the first pressure-sensitive adhesive 62 is provided on the outer edge 82, which surrounds the cover 81, of the sheet member 61 in the portable computer 10 of the present embodiment. Accordingly, generation of a plurality of parts different in colors between the back face 41b and the cover 81 is prevented, and the impairment of the fine view of the portable computer 10 is prevented.

The sheet member 61 is a translucent sheet. Thus, a contrast in color between a part, which is attached to the back face 41b by the first pressure-sensitive adhesive 62, and a part, which is not attached to the back face 41b, of the sheet member 61 is mitigated. Accordingly, the impairment of the fine view of the portable computer 10 is prevented.

When the cover 81 of e sheet member 61 covers the back face 41b of the second housing 41, the damage of the back face 41b of the second housing 41 is suppressed. In addition, a foreign substance, a liquid, and water vapor are prevented from entering into a portion between the back face 41b and the cover 81 and damaging the portable computer 10 since the space S between the back face 41b and the cover 81 is blocked by the first pressure-sensitive adhesive 62. For example, there is a case in which the user grips the portable computer 10 by the hand. The first pressure-sensitive adhesive 62 prevents sweat or water vapor generated from the users' hand from entering into the space S.

The cover 81 is provided with the opening 74 configured to surround the logotype 57. Accordingly, impairment of fine view of the logotype 57 and interference of the sheet member 61 to the logotype 57 are prevented. For example, it is also possible to inspect the logotype 57 without peeling off the sheet member 61 from the back face 41b. In addition, the second pressure-sensitive adhesive 63 is provided on the inner edge 87 that surrounds the opening 74. Accordingly, a foreign substance, a liquid, and water vapor are prevented from entering into a portion between the back face 41b and the interposed portion 88 from the opening 74, and damaging the portable computer 10.

The plurality of third pressure-sensitive adhesives 64 provided on the cover 81 allow the sheet member 61 to adhere to the back face 41b. Accordingly, undesired peeling-off of the sheet member 61 from the back face 41b is prevented.

The entire area of the plurality of third pressure-sensitive adhesives 64 being provided on the cover 81 is smaller than the area of the first pressure-sensitive adhesive 62 being provided on the outer edge 82. Thus, the third pressure-sensitive adhesive 64 is prevented from standing out, and the impairment of the fine view of the portable computer 10 is prevented.

The outer edge 82 provided with the first pressure-sensitive adhesive 62 is disposed between the cover 81 and the tab 84 which is movable with respect to the back face 41b. Accordingly, the user can easily peel off the sheet member 61 from the back face 41b by pinching the tab 84. The user can use the portable computer 10 of which the beautiful back face 41b is exposed by peeling off the sheet member 61 from the back face 41b. However, the user may use the portable computer 10 with the sheet member 61 adhering to the back face 41b. In addition, the sheet member 61 is easily peeled off from the back face 41b at the time of inspecting the back face 41b.

The tab 84 is set to protrude from the second long side 82b in the direction along the Z-axis crossing the direction along the X-axis in which the second long side 82b is extended. Accordingly, the tab 84 can be easily pinched by the user.

The curved face 41bb of the back face 41b is spaced apart from the tab 84 while overlapping with the tab 84. Accordingly, the user can enter the finger into a space between the tab 84 and the curved face 41bb, and easily pinch the tab 84.

The width of the second long side 82b is different from the width of the second short side 82d. Accordingly, the user can easily peel off the sheet member 61 from the back face 41b by setting the width of the second long side 82b to be smaller than the width of the second short side 82d in a case in which the sheet member 61 is pulled in the direction along the Z-axis when the user peels off the sheet member 61, for example.

The back face 41b to which the sheet member 61 adheres is disposed at the opposite side of the screen 42a. For example, there is a possibility that the back face 41b without the sheet member 61 is damaged although the screen 42a is covered by the base portion 11 at the time of transport. When the sheet member 61 removably adheres to the back face 41b in such a manner, the impairment of the fine view of the portable computer 10 is effectively prevented.

The first pressure-sensitive adhesive 62 is provided on the outer edge 82 using the screen printing. Accordingly, the first pressure-sensitive adhesive 62 can be easily provided on the outer edge 82 which is one of the outer edge 82 and the cover 81.

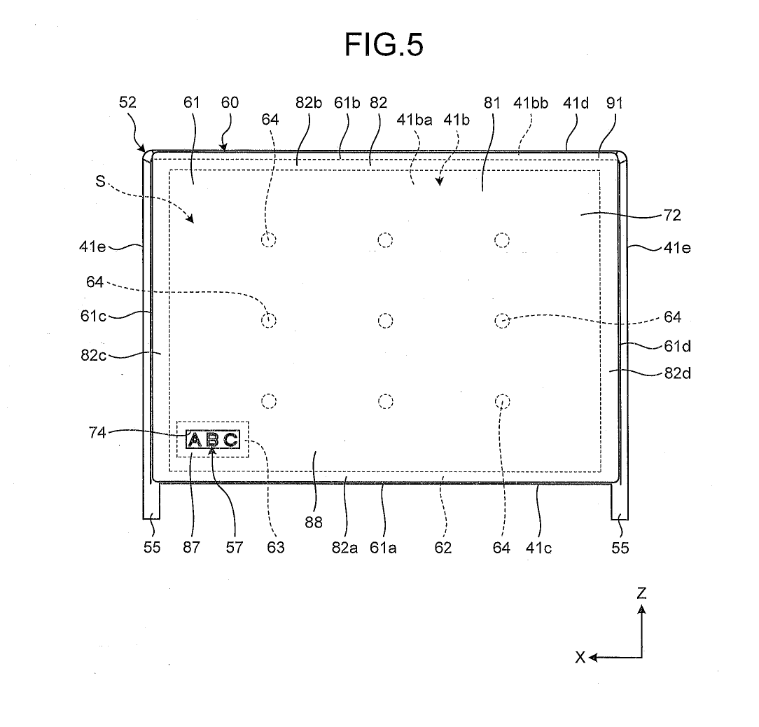

Hereinafter, a second embodiment will be described with reference to FIG. 5. Incidentally, there is a case in which constituent elements having the same functions as the constituent elements that have been already described will be attached with the same reference numerals as the above-described constituent elements, and further, descriptions thereof will be omitted in the following description regarding a plurality of embodiments. Further, a plurality of the constituent elements attached with the same reference numerals may not necessarily share the entire function and property, and may have different functions and properties according to the respective embodiments.

FIG. 5 is an exemplary plan view illustrating the back cover 52 according to the second embodiment. As illustrated in FIG. 5, the sheet 60 of the second embodiment includes an extended edge portion 91 instead of the tab 84 of the first embodiment. The extended edge portion 91 is an example of the peelable portion.

The extended edge portion 91 is set to protrude from the second long side 82b of the outer edge 82 in the positive direction along the Z-axis. The outer edge 82 is disposed between the cover 81 and the extended edge portion 91. The extended edge portion 91 is extended in the direction along the X-axis as similar to the second long side 82b of the outer edge 82. A width of the extended edge portion 91 is substantially the same as a width of the second long side 82b in the direction along the X-axis. The width of the extended edge portion 91 may be different from the width of the second long side 82b.

The extended edge portion 91 is interposed between the second end edge 61b of the sheet member 61 and the second long side 82b of the outer edge 82. The extended edge portion 91 forms a part of the pasting face 71 and a part of the outer face 72 which are adjacent to the second end edge 61b.

The second long side 82b of the outer edge 82 of the second embodiment is spaced apart from the second end edge 61b of the sheet member 61. The extended edge portion 91 is adjacent to the second end edge 61b, and the second long side 82b is adjacent to the extended edge portion 91.

Similar to the first embodiment, the first pressure-sensitive adhesive 62 of the present embodiment is provided on the outer edge 82. The first pressure-sensitive adhesive 62 is provided on the second long side 82b of the outer edge 82 which is spaced apart from the second end edge 61b of the sheet member 61 other than the extended edge portion 91.

The first to third pressure-sensitive adhesives 62 to 64 are provided outside the extended edge portion 91. The extended edge portion 91 is movable with respect to the back face 41b of the second housing 41. As illustrated in FIG. 5, the extended edge portion 91 overlaps with the curved face 41bb of the back face 41b in a case in which the back face 41b is seen in a plan view. In other words, the pasting face 71 of the extended edge portion 91 is directed in the curved face 41bb of the back face 41b. The extended edge portion 91 is spaced apart from at least apart of the curved face 41bb of the back face 41b in the negative direction along the Y-axis.

The outer edge 82 provided with the first pressure-sensitive adhesive 62 is disposed between the cover 81 and the extended edge portion 91 which is movable with respect to the back face 41b. Accordingly, the user can easily peel off the sheet member 61 from the back face 41b by pinching the extended edge portion 91.

According to the portable computer 10 of the second embodiment, the extended edge portion 91 is extended in the direction along the X-axis as similar to the second long side 82b of the outer edge 82. Accordingly, the extended edge portion 91 can be easily pinched by the user.

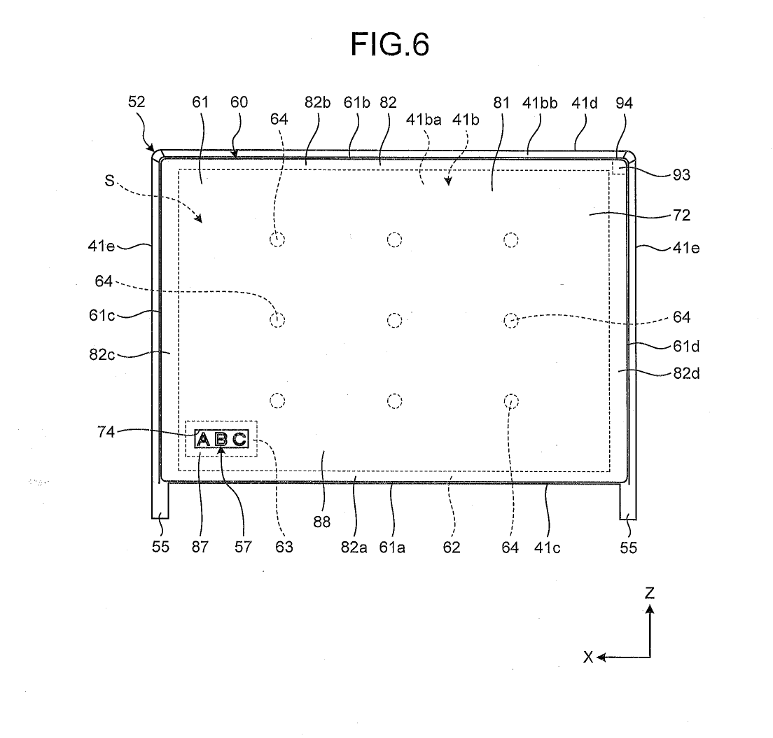

Hereinafter, a third embodiment will be described with reference to FIG. 6. FIG. 6 is an exemplary plan view illustrating the back cover 52 according to the third embodiment. As illustrated in FIG. 6, the sheet member 61 of the third embodiment includes a peelable portion 93 instead of the tab 84 and the extended edge portion 91.

The peelable portion 93 is provided in an outer corner portion 94 of the outer edge 82. The outer corner portion 94 is a part in which the second long side 82b of the outer edge 82 and the second short side 82d are connected to each other. The outer corner portion 94 is adjacent to the second end edge 61b and the fourth end edge 61d of the sheet member 61 which are outer peripheral edges of the outer edge 82. However, the outer corner portion 94 is spaced apart from a boundary between the outer edge 82 and the cover 81 which is an inner peripheral edge of the outer edge 82.

As illustrated by the broken line in FIG. 6, the peelable portion 93 is extended from the second end edge 61b and the fourth end edge 61d of the sheet member 61 toward the cover 81. However, the peelable portion 93 is spaced apart from the cover 81. The outer edge 82 is disposed between the cover 81 and the peelable portion 93. Thus, the outer edge 82 blocks the portion between the back face 41b of the second housing 41 and the interposed portion 88 of the cover 81. The peelable portion 93 forms a part of the pasting face 71 and a part of the outer face 72.

Similar to the first embodiment, the first pressure-sensitive adhesive 62 of the present embodiment is provided on the outer edge 82. The first to third pressure-sensitive adhesives 62 to 64 are provided outside the peelable portion 93. The peelable portion 93 is movable with respect to the back face 41b of the second housing 41. In the present embodiment, the peelable portion 93 overlaps with the planar face 41ba of the back face 41b in a case in which the back face 41b is seen in a plan view. However, the peelable portion 93 may overlap with the curved face 41bb of the back face 41b.

The outer edge 82 provided with the first pressure-sensitive adhesive 62 is disposed between the cover 81 and the peelable portion 93 which is movable with respect to the back face 41b. Accordingly, the user can easily peel off the sheet member 61 from the back face 41b by pinching the peelable portion 93.

According to the portable computer 10 of the third embodiment, the peelable portion 93 is provided in the outer corner portion 94 to which the second long side 82b and the second short side 82d of the outer edge 82 are connected. Thus, the peelable portion 93 is formed in a substantially triangular shape having a side extended in the direction along the X-axis and a side extended in the direction along the Z-axis, and can be easily pinched by the user.

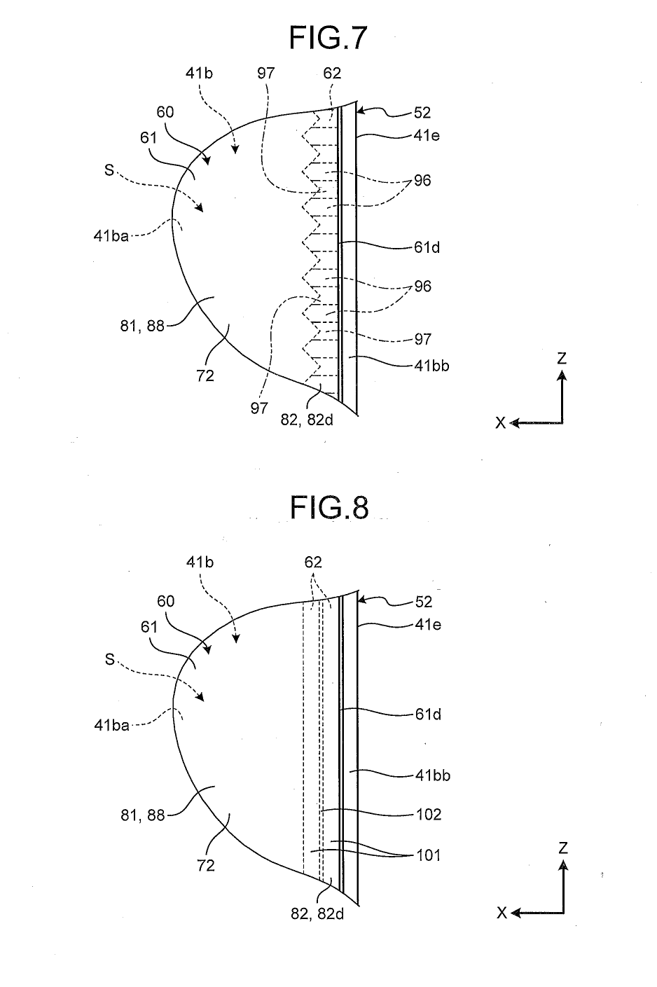

Hereinafter, a fourth embodiment will be described with reference to FIG. 7. FIG. 7 is an exemplary plan view illustrating a part of the back cover 52 according to the fourth embodiment. As illustrated in FIG. 7, a boundary between the cover 81 and the outer edge 82 is formed in a wave shape in the fourth embodiment.

To be specific, the second short side 82d of the outer edge 82 extends in the direction along the Z-axis similar to the first embodiment. The second short side 82d is an example of the first extension portion in the fourth embodiment. The direction along the Z-axis is an example of the first direction in the fourth embodiment.

The second short side 82d includes a plurality of convex portions 96 and a plurality of concave portions 97. The plurality of convex portions 96 are examples of a plurality of wide portions. The plurality of concave portions 97 are an example of a plurality of narrow portions. FIG. 7 illustrates the plurality of convex portions 96 and the plurality of concave portions 97 in a schematically separated manner by chain double-dashed lines. The plurality of convex portions 96 and the plurality of concave portions 97 are alternately disposed in the direction along the Z-axis.

Each of the convex portions 96 is a part of the outer edge 82 which includes a part protruding in the positive direction along the X-axis. In other words, the convex portion 96 includes a part protruding in the direction of being away from the fourth edge portion 61d.

Each of the concave portions 97 is a part of the outer edge 82 which includes a part recessed in the negative direction along the X-axis. In other words, the concave portion 97 includes a part recessed in the direction of approaching the fourth edge portion 61d.

Each width (dimension) of the concave portions 97 is narrower than each width of the convex portions 96 in the direction along the X-axis. The direction along the X-axis is an example of a direction orthogonal to the first direction of the present embodiment.

Each of the first long side 82a, the second long side 82b, and the first short side 82c also includes the plurality of convex portions 96 and the plurality of concave portions 97 as similar to the second short side 82d.

The plurality of convex portions 96 and the plurality of concave portions 97 are alternately disposed in the direction along the X-axis on the first long side 82a. The width of the concave portion 97 of the first long side 82a is shorter than the width of the convex portion 96 of the first long side 82a in the direction along the Z-axis.

The plurality of convex portions 96 and the plurality of concave portions 97 are alternately disposed in the direction along the X-axis on the second long side 82b. The width of the concave portion 97 of the second long side 82b is shorter than the width of the convex portion 96 of the second long side 82b in the direction along the Z-axis.

The plurality of convex portions 96 and the plurality of concave portions 97 are alternately disposed in the direction along the Z-axis on the first short side 82c. The width of the concave portion 97 of the first short side 82c is shorter than the width of the convex portion 96 of the first short side 82c in the direction along the X-axis.

Similar to the first embodiment, the first to third pressure-sensitive adhesives 62 to 64 allow the sheet member 61 to removably adhere to the back face 41b of the second housing 41. The first pressure-sensitive adhesive 62 is provided on each of the plurality of convex portions 96 and the plurality of concave portions 97. Each area of the convex portions 96 is wider than each area of the concave portions 97. Thus, the adhesion area between the first pressure-sensitive adhesive 62 provided on the convex portion 96 and the back face 41b is wider than the adhesion area of the first pressure-sensitive adhesive 62 provided on the concave portion 97 and the back face 41b.

The sheet member 61 of the fourth embodiment may include the tab 84 of the first embodiment, the extended edge portion 91 of the second embodiment, or the peelable portion 93 of the third embodiment.

According to the portable computer 10 of the fourth embodiment, the plurality of convex portions 96 and the plurality of concave portions 97, narrower than the convex portions 96, are alternately disposed on the second short side 82d. In other words, the convex portion 96 to be attached strongly to the back face 41b and the concave portion 97 to be weakly attached to the back face 41b are alternately disposed. Accordingly, the user can easily peel off the sheet member 61 from the back face 41b. In addition, a sound caused when the sheet member 61 is peeled off from the back face 41b is reduced.

Hereinafter, a fifth embodiment will be described with reference to FIG. 8. FIG. 8 is an exemplary plan view illustrating a part of the back cover 52 according to the fifth embodiment. As illustrated in FIG. 8, the outer edge 82 of the fifth embodiment includes a first part 101 and a second part 102.

The first part 101 surrounds the second part 102. In other words, the second part 102 is provided in the middle of the first part 101. The first pressure-sensitive adhesive 62 is provided on the pasting face 71 of the first part 101. The first pressure-sensitive adhesive 62 is provided outside the second part 102.

The second part 102 provided on the first long side 82a of the outer edge 82 is extended in the direction along the X-axis as similar to the first long side 82a. The second part 102 provided on the second long side 82b is extended in the direction along the X-axis as similar to the second long side 82b.

The second part 102 provided on the first short side 82c of the outer edge 82 is extended in the direction along the Z-axis as similar to the first short side 82c. The second part 102 provided on the second short side 82d is extended in the direction along the Z-axis as similar to the second short side 82d.

Similar to the first embodiment, the first to third pressure-sensitive adhesives 62 to 64 allow the sheet member 61 to be removably adhere to the back face 41b of the second housing 41. The first part 101 of the outer edge 82 is attached to the back face 41b by the first pressure-sensitive adhesive 62. A space is formed between the second part 102 and the back face 41b.

The sheet member 61 of the fifth embodiment may include the tab 84 of the first embodiment, the extended edge portion 91 of the second embodiment, or the peelable portion 93 of the third embodiment.

According to the portable computer 10 of the fifth embodiment, the outer edge 82 includes the first part 101 provided with the first pressure-sensitive adhesive 62, and the second part 102 surrounded by the first part 101. In other words, the second part 102 without the first pressure-sensitive adhesive 62 is provided in the middle of the first part 101 provided with the first pressure-sensitive adhesive 62. Accordingly, the user can easily peel off the sheet member 61 from the back face 41b. In addition, the sound caused when the sheet member 61 is peeled off from the back face 41b is reduced.

In the plurality of embodiments described above, the back face 41b includes the planar face 41ba and the curved face 41bb. However, there is a case in which a protrusion and a recess are provided on the back face 41b. In such a case, the sheet member 61 may be formed in a shape in response to the protrusion and the recess.

According to at least one of the embodiments described above, the first pressure-sensitive adhesive is provided on the outer edge of the sheet member, and is configured to block the portion between the surface of the housing and the cover of the sheet member. Accordingly, the impairment of the fine view of the apparatus is prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus comprising:
a sheet member comprising a cover and an outer edge surrounding the cover, at least apart of the sheet allowing light to pass therethrough;
a housing comprising a surface; and
a first pressure-sensitive adhesive provided on the outer edge, configured to allow the sheet member to removably adhere to the surface, and configured to block a portion between the surface and the cover.

2. The apparatus of claim 1, further comprising:
a disposed portion made of a different material from the surface and provided on the surface; and
a second pressure-sensitive adhesive configured to allow the sheet member to removably adhere to the surface,
wherein the cover comprises an inner edge which is provided with an opening configured to surround the disposed portion, surrounds the opening, and is surrounded by the outer edge at a position spaced apart from the outer edge, and an interposed portion disposed between the inner edge and the outer edge, and
the second pressure-sensitive adhesive is provided on the inner edge, and is configured to block a portion between the surface and the interposed portion.

3. The apparatus of claim 1, further comprising:
at least one third pressure-sensitive adhesive provided on the cover, spaced apart from the first pressure-sensitive adhesive, and configured to allow the sheet member to removably adhere to the surface.

4. The apparatus of claim 3, wherein
an entire area of the at least one third pressure-sensitive adhesive being provided on the cover is smaller than an area of the first pressure-sensitive adhesive being provided on the outer edge.

5. The apparatus of claim 1, wherein
the sheet member comprises a peelable portion which is movable with respect to the surface, and
the outer edge is disposed between the cover and the peelable portion.

6. The apparatus of claim 5, wherein
the outer edge comprises a first extension portion which is extended in a first direction, and
the peelable portion is set to protrude from the first extension portion in a second direction crossing the first direction.

7. The apparatus of claim 6, wherein
the peelable portion is extended in the first direction.

8. The apparatus of claim 5, wherein
the surface comprises a spacing portion which is spaced apart from the peelable portion while overlapping with the peelable portion.

9. The apparatus of claim 5, wherein
the outer edge comprises a first extension portion extended in a first direction and a second extension portion connected to the first extension portion while being extended in a third direction crossing the first direction, and
the peelable portion is provided in a part in which the first extension portion and the second extension portion of the outer edge are connected to each other.

10. The apparatus of claim 5, wherein
the outer edge comprises a first extension portion extended in a first direction and a second extension portion connected to the first extension portion while being extended in a third direction crossing the first direction, and
a width of the first extension portion in a direction orthogonal to the first direction is different from a width of the second extension portion in a direction orthogonal to the third direction.

11. The apparatus of claim 1, further comprising
a display face which is configured to display an image,
wherein the surface is disposed at an opposite side of the display face.

12. The apparatus of claim 1, wherein
the first pressure-sensitive adhesive is provided on the outer edge using screen printing.

13. The apparatus of claim 1, wherein
the outer edge comprises a first extension portion extended in a first direction, and
the first extension portion comprises a plurality of wide portions, and a plurality of narrow portions each of which has a width in a direction orthogonal to the first direction being narrower than a width of the wide portion and which are disposed alternately with the plurality of wide portions.

14. The apparatus of claim 1, wherein
the outer edge comprises a first part provided with the first pressure-sensitive adhesive and a second part surrounded by the first part.

15. A sheet comprising:
a sheet member comprising a cover and an outer edge surrounding the cover, the sheet allowing light passes therethrough; and
a first pressure-sensitive adhesive provided on the outer edge, configured to allow the sheet member to removably adhere to a surface of an object, and configured to block a portion between the surface and the cover.

16. The sheet of claim 15, further comprising
a second pressure-sensitive adhesive configured to allow the sheet member to removably adhere to the surface,
wherein the cover comprises an inner edge which is provided with an opening, surrounds the opening, and is surrounded by the outer edge at a position spaced apart from the outer edge, and
the second pressure-sensitive adhesive is provided on the inner edge, and is configured to block a portion between the surface and the cover.

17. The sheet of claim 15, further comprising
at least one third pressure-sensitive adhesive provided on the cover, spaced apart from the first pressure-sensitive adhesive, and configured to allow the sheet member to removably adhere to the surface.

18. The sheet of claim 17, wherein
an entire area of the at least one third pressure-sensitive adhesive being provided on the cover is smaller than an area of the first pressure-sensitive adhesive being provided on the outer edge.

19. The sheet of claim 15, wherein
the sheet member comprises a peelable portion which is movable with respect to the surface, and
the outer edge is disposed between the cover and the peelable portion.

20. The sheet of claim 19, wherein
the outer edge comprises a first extension portion extended in a first direction, and
the peelable portion is set to protrude from the first extension portion in a cross direction crossing the first direction.
